(19) United States
(12) Patent Application Publication
(10) Pub. No.: US 2006/0092925 A1
(43) Pub. Date: May 4, 2006

(54) Roaming between circuit-switched and all-IP networks

(75) Inventors: Sven Anders Borje Svensson, San Diego, CA (US); Martin Renschler, San Diego, CA (US); Raymond So, San Diego, CA (US)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/259,406

(22) Filed: Oct. 26, 2005

Related U.S. Application Data
(60) Provisional application No. 60/623,751, filed on Oct. 29, 2004.

(51) Int. Cl. H04L 12/66

(52) U.S. Cl. 370/352

(57) ABSTRACT

A temporary address assignment server in an IP network assigns a temporary number to use for setting up a mobile terminated call to a mobile station roaming in an IP network. The temporary number is supplied to a switching node, such as a Mobile Switching Center, in a circuit switched network. The Mobile Switching Center sets up a connection with a Media Gateway by sending a call setup message to a Media Gateway Control Function. The call setup message includes the temporary number assigned by the temporary address assignment server. The Media Gateway Control Function uses the temporary number to establish a media session with the mobile station.

### RELATED APPLICATIONS

This application claims priority under 35 U.S.C. § 119(e) from the following U.S. provisional application: Application Ser. No. 60/623,751 filed on Oct. 29, 2004. That application is incorporated in its entirety by reference herein.

### BACKGROUND

The present invention relates generally to call delivery in mobile communication networks and, more particularly, to interoperation to enable roaming by mobile stations between circuit-swtiched and all-IP networks.

Mobile communication networks are evolving toward all-IP core networks that merge voice and data communications. The IP multimedia subsystem (IMS) is one example of an IP-based core network. IMS uses the session initiation protocol (SIP) as the service control protocol. The IMS standard will speed the adoption of IP services on mobile stations, allowing users to communicate via voice, video, or text using a single client on the mobile station.

Currently, there is a large investment in circuit-switched infrastructure and a large base of legacy phones in use by consumers. Thus, the migration from conventional circuit-swtiched networks to all-IP core networks is likely to take many years. During the transition from circuit-switched to all-IP core networks, there will be a need for interoperation to allow roaming between circuit-switched and all-IP networks.

### SUMMARY

The present invention provides a method for routing a mobile terminated call from a circuit-switched network to a mobile station running in an IP network. A temporary address assignment server in the IP network assigns a temporary number to use for setting up the call. The temporary number is supplied to a switching node, such as a Mobile Switching Center, in the circuit switched network. The Mobile Switching Center sets up a connection with a Media Gateway by sending a call setup message to a Media Gateway Control Function. The call setup message includes the temporary number assigned by the temporary address assignment server. The Media Gateway Control Function uses the temporary number to establish a media session with the mobile station.

In one embodiment, the media gateway control function uses the Session Initiation Protocol (SIP) to set up the media session with the mobile station. The Media Gateway Control Function sends a SIP INVITE request to the temporary number assigned by the temporary address assignment server. The SIP INVITE request is forwarded to the temporary address assignment server, which maps the temporary number to a signaling address for the mobile station and sends a redirection response to the media gateway control function. The Media Gateway Control Function then uses the signaling address provided by the temporary address assignment server to set up the media session with the mobile station.

### BRIEF DESCRIPTION OF THE DRAWINGS

FIG. 1 illustrates an exemplary integrated communication network.

FIG. 2 illustrates the main elements of circuit-switched and all-IP core networks.

FIGS. 3A-3C are a call flow diagram illustrating a procedure for call delivery to a mobile station roaming in an all-IP network.

### DETAILED DESCRIPTION

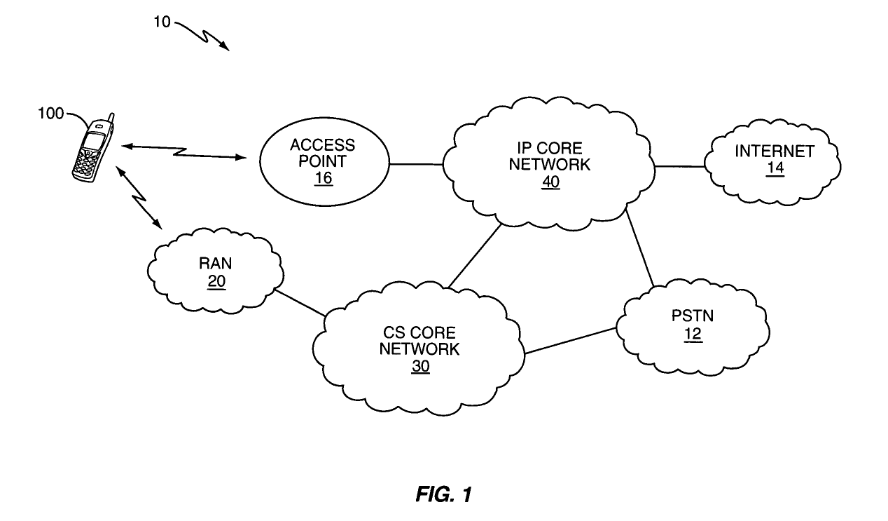

FIG. 1 illustrates an exemplary integrated network indicated generally by the numeral 10. Network 10 includes a radio access network (RAN) 20, a circuit-switched core network (CS-CN) 30, and an all-IP core network (IP-CN) 40. The RAN 20 supports radio communications with mobile stations 100 over an air interface. The RAN 20 may comprise, for example, a UMTS RAN (UTRANS), CDMA2000, GSM, or other packet-based radio access network. The wireless network 10 typically includes more than one RAN 20 though only one is shown in FIG. 1. The CS-CN 30 provides a connection to the Public Switched Telephone Network (PSTN) 12 and/or the Integrated Digital Services Network (ISDN) for circuit-switched services, such as voice and fax services. The CS-CN 30 interconnects with the IP-CN 40. The IP-CN 40 provides access to the Internet or other packet data network (PDN) 14. A mobile station 100 accesses the IP-CN 40 via an access point 18, which may comprise, for example, a WiFi hotspot according to the IEEE 802.11 standards

The IP-CN 40 uses open interfaces and an access independent session control protocol (SCP), such as the Session Initiation Protocol (SIP), to support multi-media applications, such as voice over IP (VolP). SIP is an application layer control protocol for establishing, modifying and terminating communication sessions between one or more participants. These sessions may include, for example, Internet multimedia conferences, Internet telephony calls, multimedia distributions and network gaming. The SIP is described in the Internet Engineering Task force (IETF) document RFC 3261. While a preferred embodiment of the invention as described herein uses the SIP, those skilled in the art will appreciate that the present invention may be employed with other SCPs as well. Another well-known protocol comparable to SIP is H. 323.

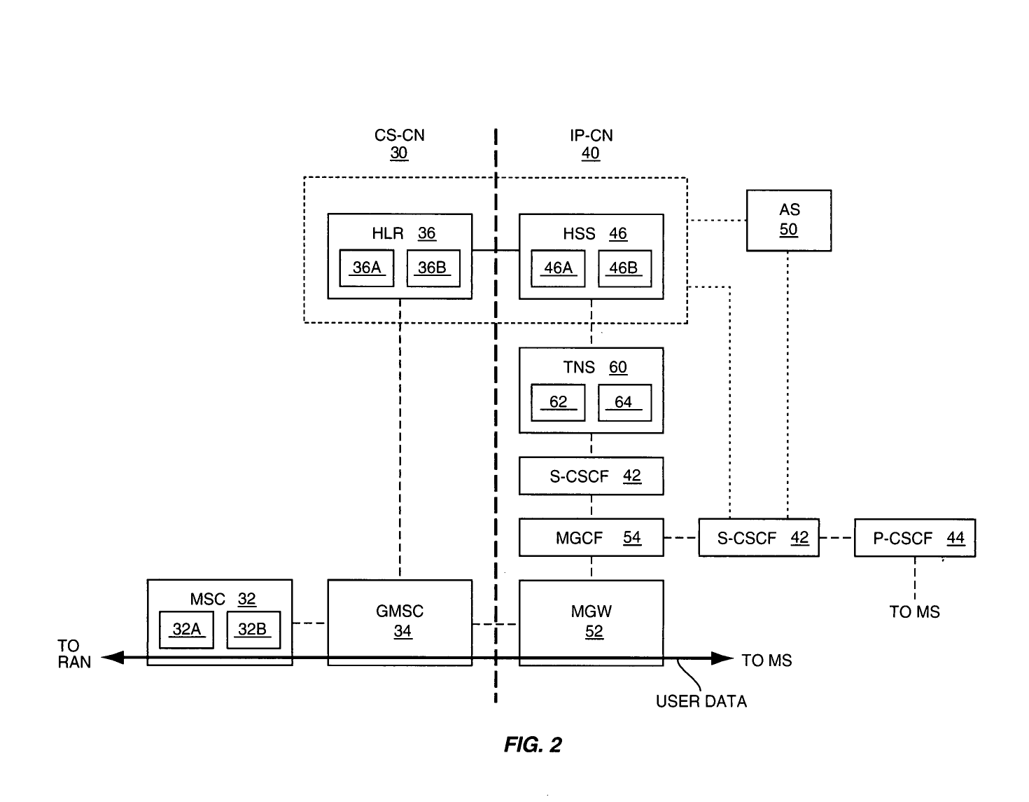

FIG. 2 illustrates the main elements of the CS-CN 30 and IP-CN 40. The CS-CN 30 may comprise, for example, an ANSI-41 or GSM MAP network. The CS-CN 30 includes one or more Mobile Switching Centers (MSCs) 32, at least one of which functions as a Gateway MSC (G-MSC) 34, and a Home Location Register (HLR) 36. The MSC 32 includes call processing circuits 32a and switching circuits 32b for setting up and routing calls to and from the mobile station 100. The G-MSC 34 provides connection to the PSTN 12 and other external networks. The HLR 36 is the network entity that is responsible for keeping track of the location of the mobile station 100. The HLR 36 comprises a subscriber database 36a for storing subscriber information, and a server 36b for updating the subscriber database 36 and responding to queries from other network entities. The subscriber information stored by the subscriber database 36a includes location information, subscriber status, service information and directory numbers.

The IP-CN 40 may be an IP network as specified in the Third Generation Partnership Project 2 (3GPP2) standards S.R0037-0 v3.4. The IP-CN 40 includes one or more Call State Control Functions (CSCFs) including a Proxy CSCF (P-CSCF) 44 and one or more Serving CSCFs (S-CSCFs) 42, a Home Subscriber Register (HSR) 46, and an application server (AS) 50 for providing IP call services to mobile stations 100. The IP-CN 40 further includes a Media Gateway (MGW) 52, a Media Gateway Control Function (MGCF) 54, and a Transport Signaling Gateway (T-SGW) 56 to enable interoperation with circuit-switched networks, such as CS-CN 30 and PSTN 12. Other network architectures could also be used, such as the IP Multimedia Subsystem (IMS) network architecture or the network architecture described in the Third Partnership Project (3GPP) standard TS 23.228.

The CSCFs 42 and 44 function as SIP servers to handle session control signaling used to establish, maintain and terminate a communication session. The P-CSCF 42 is the first contact point for the mobile station 100, which forwards SIP signaling messages to and from the mobile station 100. The S-CSCF 44 provides session control and registration services for the mobile station 100. The HSS 46 is the equivalent of the HLR 36. The HSS 46 includes a subscriber database 46a to maintain subscriber information, and a server 46b to update the subscriber database 46a and support the other network entities. The HSS 46 may be combined with the HLR 36 to provide an integrated Home Subscriber Server (HSS) for both networks.

The MGW 52, MGCF 54 and T-SGW 56 support interworking with external networks, such as the PSTN 12 or ISDN. The MGW 52 interfaces the media plane of the IP-CN 40 with the PSTN 12 and CS-CN 30, while the T-SGW 56 interfaces the signaling plane of the IP-CN 40 to the SS7 network and CS-CN 30. The MGCF 54 controls the resources of the MGW 52 and performs protocol conversion. The MGCF 54 converts SIP messages into a different format, such as ISDN User Part (ISUP) messages, for transmission to circuit-swtiched networks, and forwards the converted messages to the T-SGW 56. The T-SGW 56 includes a protocol converter to convert IP messages to SS7 and vice versa. Media destined for or arriving from either the PSTN 12 or CS-CN 30 passes through the MGW 54.

The AS 50 provides IP call services to the mobile station 100. Call services include call features such as call blocking, call waiting, caller ID, call forwarding and three-way calling. The AS 50 is not, however, a required element of the invention. IP calls may be made to or from the mobile station 100 without the services of the AS 50.

The IP-CN 40 further includes a new network entity referred to herein as a Temporary Address Assignment Server (TAAS) 60. The TAAS 60 is a new network entity that provides seamless roaming between the CS-CN 30 and IP-CN 40 by mobile stations 100 using a single phone number to route calls in both networks. As will be described in more detail below, the TAAS 60 functions as a temporary address assignment server to assign a temporary number used to routed mobile terminated calls in the IP-CN 40. The TAAS 60 communicates with the HLR/HSS using conventional signaling protocols. The TAAS 60 communicates with network entities in the IP-CN 40 using the Session Initiation Protocol (SIP) and functions as a redirect server for routing calls to the mobile station 100.

SIP is the session control protocol used in the exemplary IP-CN 40 to establish, modify and terminate media sessions. SIP uses text-based messages to establish a conference or call between two or more participants. Users are identified by a unique address referred to herein as the SIP address. Users register with a registrar server using their assigned SIP addresses. The registrar server provides this address to a location server upon request.

When a user initiates a call, a SIP request called an INVITE request is sent to the called party. The INVITE request includes the calling party address and called party address in a message header. If a proxy server receives the INVITE request, it forwards the INVITE request to the called party. The called party sends an OK response to the INVITE request to accept the call. The proxy server forwards the OK response to the calling party. The calling party sends an ACK response to confirm the session. Media, such as audio and video, can then be transferred between the parties using RTP or MSRP for media transport over an IP network.

If a redirect server receives the INVITE request, the redirect server contacts a location server to determine the path to the called party, and then sends that information to the calling party in a redirection response. The calling party may then send another INVITE request to the address identified in the redirection response (which could be the called party or a proxy server). When the INVITE request reaches the called party, the called party responds with an OK response to accept the call, and the calling party confirms by sending an ACK response.

SIP enables applications residing in mobile devices operating within the wireless network 10 to establish RTP and MSRP sessions with other applications in remote devices. The remote applications may reside in another mobile station 100, in a computer connected to a fixed network, or in an application server in the IP-CN 40. Additionally, the applications may reside in different networks 10.

The mobile station 100 is a dual mode mobile station 100 capable of operation in both the CS-CN 30 and IP-CN 40. When the mobile station 100 is roaming in the IP-CN 40, a call for the mobile station 100 may originate in its home network. The present invention provides a mechanism for routing the call to the mobile station 100 without having to assign the mobile station 100 a separate directory number for use only in the IP-CN 40. Thus, the present invention allows the mobile station 100 to be reached in either the IP-CN 40 or CS-CN 30 using the same directory number.

As noted above, the TAAS 60 is a network entity used to setup a mobile terminated call originating in a circuit-swtiched network for the mobile station 100 when the mobile station 100 is roaming in the IP-CN 40. The call may originate in either the PSTN 12 or in the CS-CN 30. As will be described in greater detail below, the TAAS 60 assigns a Temporary Location Directory Numbers (TLDN) to the mobile station 100 to facilitate call delivery and set-up. The TAAS 60 is selected from a pool of TLDNs allocated to the TAAS 60. The TAAS 60 includes a database 62 for storing temporary associations between the assigned TLDNs and corresponding signaling addresses for the mobile stations 100, e.g., SIP addresses. The TAAS 60 also includes a SIP server 64 functioning as a redirect server. Once the call is established, the TLDN is released and can be assigned to other mobile stations 100. Thus, the TLDN becomes immediately available once the call to the mobile station 100 is established.

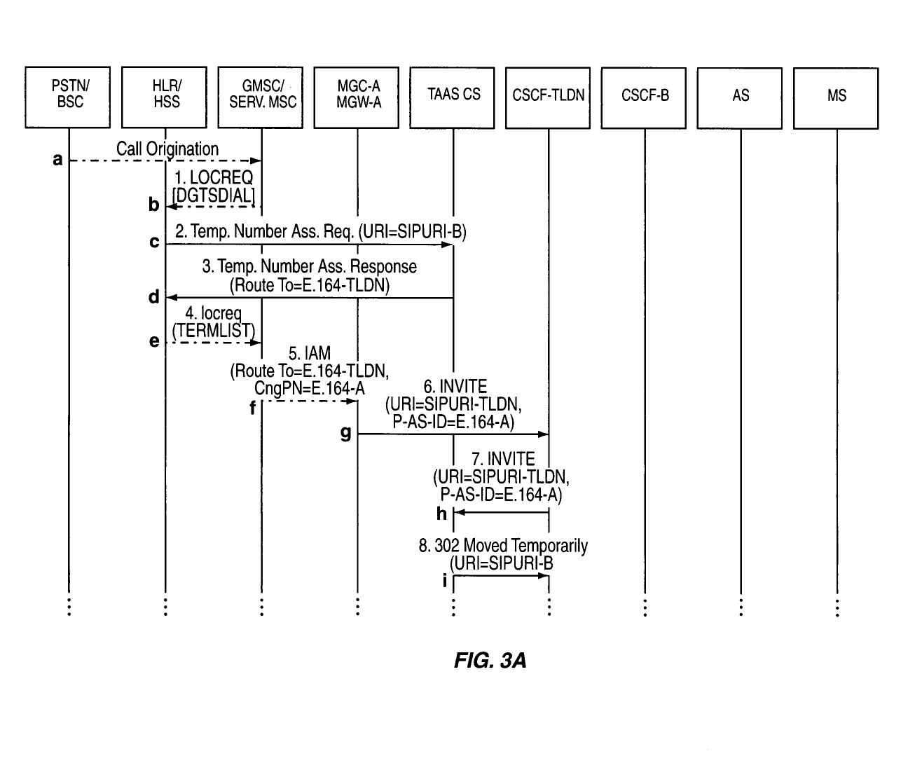

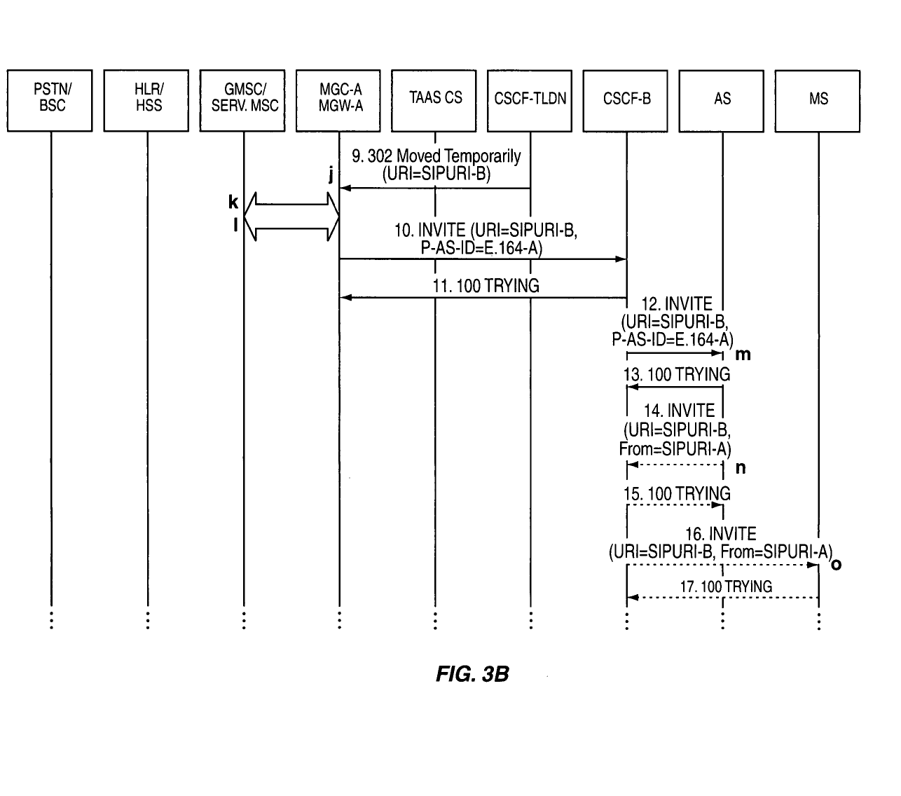

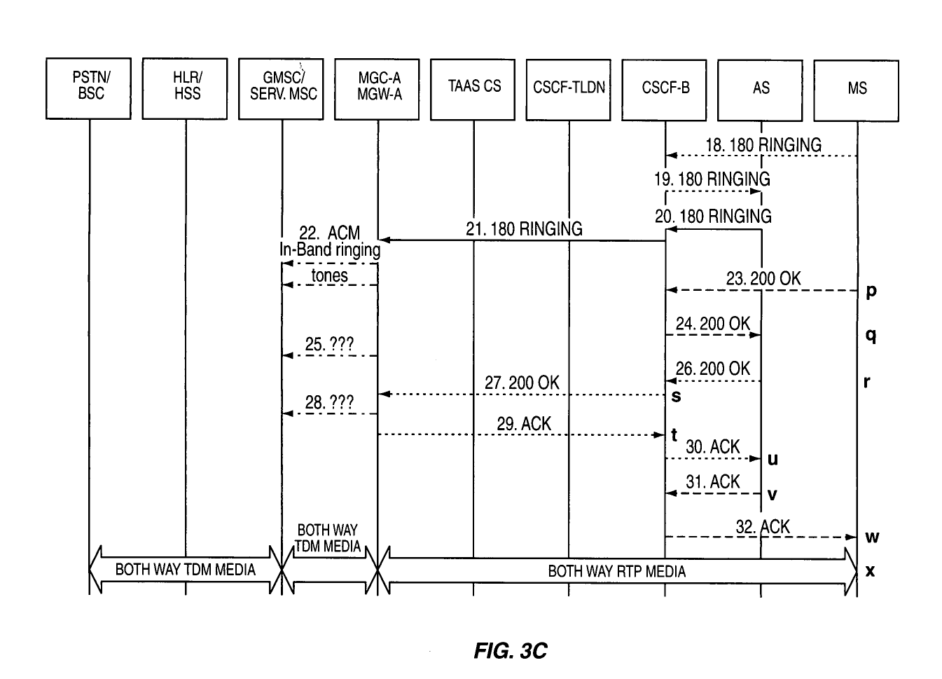

FIG. 3 illustrates an exemplary call setup procedure for setting up a mobile terminated call for the mobile station 100 while it is roaming in the IP-CN 40. The MSC 32 receives a call origination request from the PSTN 12 or RAN 20, which it forwards to the MSC 32 (step a). The call origination message includes the dialed mobile station directory number i.e. the dialed digits. The MSC 32 sends a location request message (LOCREQ) to the HLR 36 in the mobile stations' home network (step b). The selection of the HLR 36/HSS 46 is made on the basis of the of the mobile station directory number. The mobile stations' record in the HLR 36/HSS 46 indicates that the mobile station 100 desires to have its call terminated through the IP-CN 40. The HLR 36/HSS 46 sends a temporary number assignment request to the TAAS 60 (step c). The request includes the mobile station's SIP address or other signaling address denoted herein as SIPURI-B. The TAAS 60 allocates one of the TLDNs to the mobile station 100 and returns the selected TLDN to the HLR 36/HSS 48 in a temporary number assignment response (step d). The TLDN may be a directory number according to CCITT recommendation E.164, which is denoted in the FIGS. as E.164-TLDN. The TAAS 60 also creates a temporary association between the mobile station signaling address and the assigned TLDN and stores this association in its database. Upon receipt of the temporary number assignment response from the TAAS 60, the HLR 36/HSS 48 sends a location request response message (locreq) to the GMSC 34 including the assigned TLDN in the TERMLIST field (step e).

The MSC 32 initiates a call to the assigned TLDN by sending an Initial Address Message (IAM) as specified by ISDN User PART (ISUP) to the MGCF 54 in the IP-CN 40 (step f). The IAM includes the TLDN allocated by the TAAS 60 to the mobile station 100 in the RouteTo field, and the directory number of the calling party in the Calling Party field, which is denoted in the Figures as E. 164-A. The MGCS 54 queries ENUM for the SIP user address associated with the TLDN in the called party field of the IAM and generates a SIP INVITE. The SIPURI corresponding to the TLDN, denoted as SIPURI-TLDN, is the SIP address of the TAAS 60. The MGCF 54 generates a SIP INVITE with SIPURI-TLDN in the called party field and the directory number of the calling party in the P-Asserted-ldentity (P-AS-ID) field. The P-AS-ID field is used between trusted intermediaries (proxies) to assert the identity of a user agent that has been authenticated and is a standard SIP field. The SIP INVITE is sent to a serving CSCF 42 in the IP-CN 40 (step g), which forwards the SIP INVITE to the TAAS 60 (step h). The serving CSCF for the TAAS 60 is denoted in the Figures as CSCF-TAAS. Upon receipt of the SIP INVITE, the TAAS 60 maps SIPURI-TLDN in the SIP INVITE to the signaling address for the mobile station 100, denoted SIPURI-B, stored in its database. The TAAS 60 returns a redirect message containing SIPURI-B to the serving CSCF (step i) fo the TAAS, which in turn forwards the redirect message to the MGCF 54 (step j).

The remaining portion of the call flow illustrates conventional SIP signaling to set-up a media session with the mobile station 100. For simplicity, provisional responses to SIP requests shown in the call flow are not described. The MGCF 54 generates a SIP INVITE with SIPURI-B in the called party field and the calling party number in the PS-AS-ID field. The SIP INVITE is sent to the serving CSCF 42 with which the mobile station 100 has previously registered (step 1). The serving CSCF for the mobile station 100 is denoted in the Figures as CSCF-B. Based on subscription trigger data stored in the serving CSCF 42 during mobile station registration, the serving CSCF 42 for the mobile station 100 forwards the SIP INVITE to the application server 50 for the mobile station 100 (step m). Based on the subscriber profile for the mobile station 100, the application server 50 determines that the mobile station 100 shall have the incoming call delivered to the mobile station and returns a SIP INVITE to the serving CSCF 42 (step n) for the mobile station 100. The SIP INVITE includes the SIP address of the calling party, denoted SIPURI-A, in the FROM field. The serving CSCF 42 forwards the SIP INVITE to the mobile station 100 (step o). The mobile station 100 sends a SIP OK to the serving CSCF 42 to accept the SIP INVITE (step p), which propagates back to the MGCF 54 via the serving CSCF 42 and application server 50 (steps q, r and s). The MGCF 54 confirms the media session by sending a SIP ACK response towards the mobile station 100 (step t), which propagates back to the mobile station 100 via the serving CSCF 42 and application server 50 (steps u, v and w) and the media session is established. The parties can begin sending data using MSRP or RTP (step x).

The temporary address assignment server 60 facilitates call delivery to a mobile station 100 roaming in the IP-CN 40 without the need to assign a separate directory number to the mobile station for use in the IP-CN 40. Using the present invention conserves directory numbers, which are a scarce resource. Further, the present invention allows the temporary number to be released after the call is established. The temporary number can then be reassigned to set-up additional calls for other parties.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of call delivery to a roaming mobile station to enable interworking between a circuit-switched home network and an IP network, said method comprising:
receiving an origination request at a mobile switching center in said home network of the mobile station;
sending a location request from said mobile switching center to a home location
register in the home network responsive to said origination request sending a temporary number request from said home location register to a temporary address assignment server in said IP network, said temporary number request including a signaling address for said mobile station in said IP network;
allocating a temporary number to said mobile station and associating said temporary number with said signaling address for said mobile station;
returning said temporary number to said home location register responsive to said temporary number request;
forwarding said temporary number from said home location register to said mobile switching center;
sending a call set-up message including said temporary number from said mobile switching center to a media gateway control function in said IP network to set-up a circuit connection between said mobile switching center and a media gateway;
establishing a media connection between said media gateway and said home network;
sending an call invitation from said media gateway control function to said temporary number received from said mobile switching center; and redirecting said call invitation to the mobile station.

2. The method of claim 1 wherein redirecting said call invitation comprises:
forwarding said call invitation to said temporary address assignment server;
mapping said temporary number to said signaling address for said mobile station stored by said temporary address server;
sending a redirection response including said signaling address from said temporary address server to said media gateway; and
sending a second call invitation from said media gateway to said signaling address of said mobile station to initiate a media session with said mobile station.

3. A communication network comprising:
a mobile switching center including a call processing circuit operative to:
receive an origination request for a mobile terminated call to a mobile station roaming in an IP network;
send a location request to a home location register responsive to said origination request;
receive a location request response including a temporary number assigned to said mobile station from said home location register;
send an initial address message including a said temporary number to a media gateway;
a home subscriber server operative to:
receive said location request from said mobile switching center;
send a temporary number request to a temporary address server, said temporary number request including a signaling address for said mobile station in said IP network;
receive a temporary number assignment from said temporary address assignment server;
send a location request response to said mobile switching center including said assigned temporary number;
a temporary address assignment server operative to:
receive said temporary number request from said home location register;
assign a temporary number to said mobile station responsive to said temporary number request;
store said temporary number and said signaling address in a temporary directory;
receive a call set-up message including said previously assigned temporary number;
redirect said call- set-up message to said mobile station signaling address;
a media gateway control function including a call processing circuit operative to:
receive a call set-up message from said mobile switching center including said temporary number; and
establish a media session with said mobile station using said temporary number responsive to said call set-up message.

4. The communication network of claim 3 wherein the media gateway control function establishes a media session with said mobile station by sending a first invitation to the temporary number, receiving a redirection message including the signaling address of the mobile station responsive to the first invitation, and sending a second invitation to the signaling address contained in the redirection message.

5. The communication network of claim 4 wherein said temporary number serves is further operative to receive said first invitation from said media gateway control function, and to redirect said invitation by sending a redirection response to said media gateway control function.

6. A method of facilitating a call to a mobile station roaming in an IP network, said method comprising:
assigning a temporary number to a mobile station;
associating the temporary number with a signaling address of said mobile station and storing said association in memory;
receiving a call invitation including said temporary number from a media gateway control function; and
redirecting said invitation to said signaling address of said mobile station to initiate a media session with said mobile station.

7. The method of claim 6 wherein said invitation comprises a SIP INVITE request.

8. The method of claim 7 wherein redirecting said invitation comprises sending a SIP redirection response to said media gateway control function, said redirection response including a signaling address for said mobile station.

9. The method of claim 8 further comprising establishing a media session said mobile station.

10. The method of claim 9 wherein establishing a media session with said mobile station comprises sending a call invitation to said signaling address of said mobile station.

11. A temporary address assignment server to enable interworking between a circuit-swtiched network and an IP network, said temporary address assignment server comprising:
a server for allocating temporary numbers to mobile stations roaming in said IP network, and storing said temporary numbers along with corresponding signaling addresses of said mobile stations in a database;
a SIP server to receive call invitations for said mobile stations, said call invitations including a previously assigned temporary number, and to redirect said call invitations to the signaling address associated with said temporary number in said database.

12. The temporary address assignment server of claim 11 wherein said call invitation comprise a SIP INVITE request.

13. The temporary address assignment server of claim 12 wherein said signaling processor redirects said call invitation by sending a SIP redirection response to the originator of the call invitation.

14. A method of facilitating a call to a mobile station roaming in an IP network, said method comprising:
receiving a location request from a switching node in a circuit-swtiched network, said request including a signaling address in said IP network;
obtaining a temporary number from a temporary address assignment server;
forwarding a signaling address in said IP network for said mobile station to said temporary address assignment server;
forwarding said temporary number received from said temporary address assignment server to said switching node.

15. The method of claim 14 wherein obtaining a temporary number from a temporary address assignment server comprises sending a temporary number request to said temporary address assignment server responsive to said location request if said mobile station is roaming in said IP network.

16. A home subscriber server to enable interworking between a circuit-swtiched network and an IP network, said home subscriber server comprising:
a subscriber database for storing subscriber information, including location information and signaling addresses;
a server operatively connected to said subscriber database, said server operative to:
obtain a temporary number from a temporary address assignment server;
forward a signaling address for said mobile station to said temporary address assignment server; and
forward said temporary number received from said temporary address assignment server to said switching node.

17. The home subscriber server of claim 16 wherein the server obtains said temporary number by sending a temporary number request to said temporary address assignment server responsive to a location request from a switching node.
